(19) United States
(12) Patent Application Publication
(10) Pub. No.: US 2020/0078614 A1
(43) Pub. Date: Mar. 12, 2020

(54) CONFIGURABLE MOTOR CONTROL

(71) Applicant: SCOTT TECHNOLOGIES, INC., Monroe, NC (US)

(72) Inventors: Erik J. Hatinen, Monroe, NC (US); Todd R. Hunter, Calgary (CA)

(21) Appl. No.: 16/614,184

(22) PCT Filed: May 17, 2019
(86) PCT No.: PCT/US2018/033120

§ 371 Date: Nov. 15, 2019

Related U.S. Application Data
(60) Provisional application No. 62/512,429, filed on May 30, 2017.

(51) Int. Cl. A62B 9/00; H02K 11/33; H02P 23/00

(52) U.S. Cl. CPC A62B 9/00; H02K 2211/03; H02P 23/0077; H02K 11/33

(57) ABSTRACT

According to one aspect of the invention, a motor control system for driving a motor for a powered air purifying respirator (PAPR) is provided. The motor control system includes a control printed circuit board assembly (PCBA) including a control processing circuitry and a motor drive PCBA in communication with the control PCBA and the motor. The motor drive PCBA includes a motor drive processing circuitry. The control processing circuitry is configured to configure the motor drive processing circuitry with at least one operating characteristic. The motor drive processing circuitry is configured to drive the motor according to the at least one operating characteristic.

### TECHNICAL FIELD

This disclosure relates to motor control, and in particular to a method and system for dynamically configuring a motor drive printed circuit board assembly for driving a motor such as may be used in a powered air purifying respirator.

### BACKGROUND

Powered air purifying respirators (PAPRs) are used in various environments to filter ambient air in the environment to remove pollutants, pathogens, etc. The clean air is then delivered to the user. When designing new PAPRs, there are requirements placed on the new designs such as flow rate, face piece type, filter type, alarm conditions, battery life, response to alarms, user interface, etc., that all effect how the PAPR responds and functions. In order to meet these various design requirements, each PAPR requires specific firmware that depends on all of the above requirements to, in part, drive the blower motor according to these requirements.

All of these requirements for the PAPR are usually handled by a single microcontroller that handles all of the functionality stated by the requirements as well as motor control. This usually means a new printed circuit board (PCB) and firmware for each PAPR are needed to handle the different functionality of each PAPR. This also requires a microcontroller with sufficient processing power to handle all of the requirements.

However, existing solutions are firmware and/or hardware dependent to accommodate the new features and motor drive programmatic code. In other words, each separate PAPR configuration and/or design requires a different PCB board with corresponding firmware to provide specific requirements and to drive the motor accord to these specific requirements.

### SUMMARY

Some embodiments advantageously provide a method and motor control system for dynamically configuring a motor drive printed circuit board assembly and a powered air purifying respirator having the dynamically configured motor drive printed circuit board assembly.

According to one aspect of the invention, a motor control system for driving a motor for a powered air purifying respirator (PAPR) is provided. The motor control system includes a control printed circuit board assembly (PCBA) including a control processing circuitry and a motor drive PCBA in communication with the control PCBA and the motor. The motor drive PCBA includes a motor drive processing circuitry. The control processing circuitry is configured to configure the motor drive processing circuitry with at least one operating characteristic. The motor drive processing circuitry is configured to drive the motor according to the at least one operating characteristic.

According to one embodiment of this aspect, the control processing circuitry configures the motor drive processing circuitry with at least one operating characteristic in response to startup of both the control PCBA and motor drive PCBA. According to one embodiment of this aspect, the at least one operating characteristic includes at least one of proportional-integral-derivative (PID) loop parameters, minimum speed, maximum speed, default speed, ramp rates, motor configuration, current limit and current limit response. According to one embodiment of this aspect, while the motor drive processing circuitry is driving the motor according to the at least one operating characteristic. The control processing circuitry is configured to communicate at least one command to the motor drive processing circuitry. The at least one command modifies the at least one operating characteristic.

According to one embodiment of this aspect, the at least one command includes a direction of motor rotation, proportional-integral-derivative (PID) loop parameter, number of pole pairs and ramp up rate. According to one embodiment of this aspect, the motor drive processing circuitry is configured to: detect that the motor is operating outside of the at least one operating characteristic and indicate the detection to the control processing circuitry. The control processing circuitry configured to communicate at least one command to the motor drive processing circuitry in response to the indication of the detection. The at least one command modifies the at least one operating characteristic. According to one embodiment of this aspect, the at least one operating characteristic includes at least one of a motor power, motor ground, logic power, logic ground, mode pin and pulse-width modulation (PWM) control.

According to another aspect of the invention, a method for a motor control system for driving a motor for a powered air purifying respirator (PAPR) is provided. The motor control system includes a control PCBA and a motor drive PCBA. The control PCBA includes control processing circuitry. The motor drive PCBA includes motor drive processing circuitry and is in communication with the motor. The motor drive processing circuitry is configured with at least one operating characteristic. The motor is driven according to the at least one operating characteristic.

According to one embodiment of this aspect, the configuration of the motor drive processing circuitry with at least one operating characteristic is in response to startup of both the control PCBA and motor drive PCBA. According to one embodiment of this aspect, the at least one operating characteristic includes at least one of proportional-integral-derivative (PID) loop parameters, minimum speed, maximum speed, default speed, ramp rates, motor configuration, current limit and current limit response. According to one embodiment of this aspect, while the motor drive processing circuitry is driving the motor according to the at least one operating characteristic. The method further includes communicating at least one command to the motor drive processing circuitry. The at least one command modifies the at least one operating characteristic.

According to one embodiment of this aspect, the at least one command includes a direction of motor rotation, proportional-integral-derivative (PID) loop parameter, number of pole pairs and ramp up rate. According to one embodiment of this aspect, a detection is made that the motor is operating outside of the at least one operating characteristic. The detection is indicated to the control processing circuitry. At least one command is communicated to the motor drive processing circuitry in response to the indication of the detection. The at least one command modifies the at least one operating characteristic. According to one embodiment of this aspect, the at least one operating characteristic includes at least one of a motor power, motor ground, logic power, logic ground, mode pin and pulse-width modulation (PWM) control.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 is a block diagram of an exemplary PAPR system having an integrated motor controller in accordance with the principles of the disclosure;

FIG. 2 is a flow diagram of an example control process of control code in accordance with the principles of the disclosure

FIG. 3 is a flow diagram of an example motor drive process of motor drive code in with the principles of the disclosure;

FIG. 4 illustrates a block diagram of an example PAPR system for controlling functions of a motor for the PAPR system in accordance with the principles of the disclosure; and

FIG. 5 is a block diagram of an alternative embodiment of the motor control system in accordance with the principles of the disclosure.

### DETAILED DESCRIPTION

The instant disclosure advantageously provides a motor drive printed circuit board (PCB) that can change the manner in which it operates via communication, e.g., digital wired or wireless, from another or control PCBA. This allows a single blower and motor drive assembly, i.e., an assembly for a powered air purifying respirators (PAPR), to operate using one of a group of feature sets depending on the requirements for various PAPR configurations. Further, the disclosure advantageously allows the possibility to use different blower and motor drive combinations for further flexibility in designing PAPRs.

In some embodiments, a control printed circuit board (PCB) has all of the circuitry and programmatic code to meet operational and implementation requirements such as user interface, sensors, alarm response, etc. The control PCB also contains all of the information for the final product requirements regarding control of the motor outlined above. In some embodiments, the control PCB can have lower processing power because motor control functions are handled by a motor drive PCB. The motor drive PCB has a microprocessor that is dedicated to controlling the motor according to the information it receives, where the microprocessor of the motor drive PCB is less powerful than the microprocessor of the control PCB.

The disclosure advantageously allows the motor control code to be written once, with one motor drive PCB, to accommodate many different product variations with corresponding varying requirements. One motor drive PCB assembly (PCBA) has one set of firmware to control the motor. This advantageously allows one stock keeping unit (SKU) for a motor drive PCB that can be reprogrammed dynamically in the product depending on the requirements. In other words, any motor control function can be digitally programmed in PAPR 10 via the control PCB. While the embodiments described herein are described with respect to PAPR 10, the disclosure is not limited to a PAPR and is equally applicable to other types of motor control systems where one motor control assembly is desired which can then be customized based on a feature set selected from a group of feature sets depending on user and/or manufacture requirements. Such arrangements may be implemented, for example, with brushless DC motors.

Before describing in detail exemplary embodiments, it is noted that the embodiments reside primarily in combinations of components and processing steps related to methods and apparatus. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first,” “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

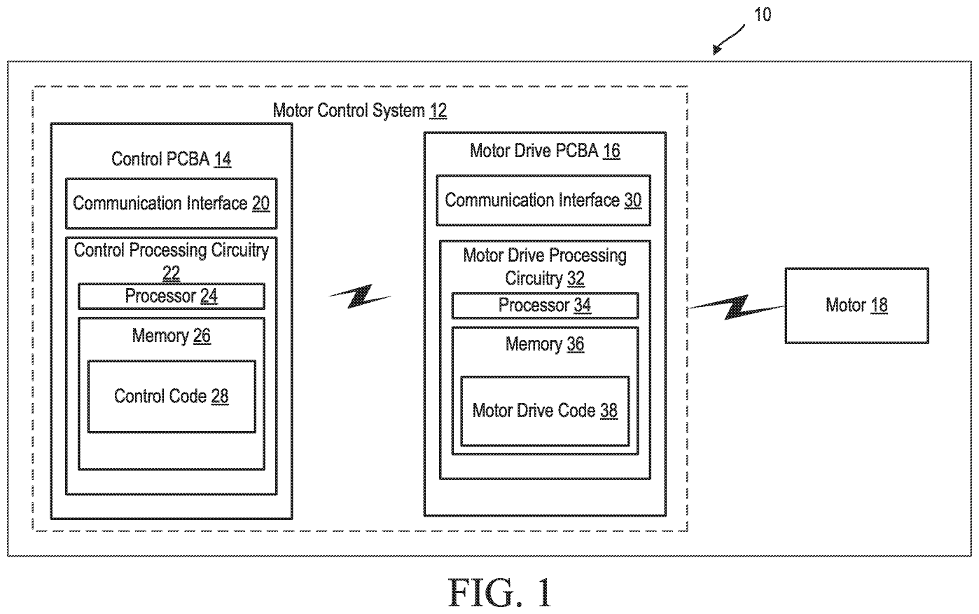

Referring now to drawing figures in which like reference designators refer to like elements there is shown in FIG. 1 a block diagram of an exemplary PAPR system, generally referred to as PAPR “10.” PAPR 10 includes motor control system 12. Motor control system 12 includes one or more control PCBAs 14 and one or more motor drive PCBAs 16. PAPR 10 includes one or more motors 18. Control PCBA 14 is in communication with motor drive PCBA 16 via one or more communication protocols for communication one or more configurations and one or more commands, as described herein. The one or more communication protocols may include BLUETOOTH or another wireless protocol. Motor drive PCBA 16 is in communication with one or more motors 18 such as to drive motor 18. In one or more embodiments, motor 18 is a brushless motor. In some embodiments, motor 18 is a blower motor for PAPR 10.

Control PCBA 14 includes communication interface 20 for communicating with motor drive PCBA. In one or more embodiments, communication interface 20 is replaced by or includes transmitter circuitry and receiver circuitry. Control PCBA 14 includes control processing circuitry 22. Control processing circuitry 22 includes processor 24 and memory 26. In addition to a traditional processor and memory, control processing circuitry 22 may include integrated circuitry for processing and/or control, e.g., one or more processors and/or processor cores and/or FPGAs (Field Programmable Gate Array) and/or ASICs (Application Specific Integrated Circuitry). Processor 24 may be configured to access (e.g., write to and/or reading from) memory 26, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory 26 may be configured to store code executable by processor 24 and/or other data, e.g., data pertaining to communication, e.g., configuration of motor control system 12, etc.

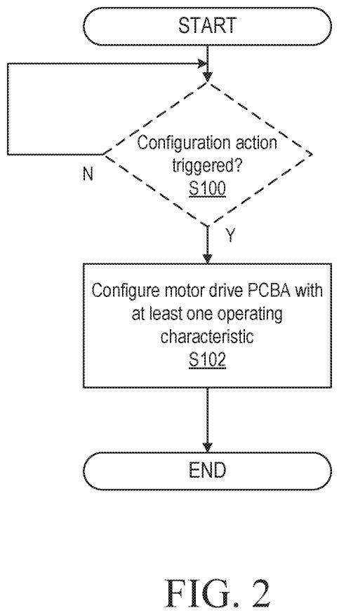

Control processing circuitry 22 may be configured to control any of the methods and/or processes described herein and/or to cause such methods, signaling and/or processes to be performed, e.g., by control PCBA 14. Processor 24 corresponds to one or more processors 24 for performing control PCBA 14 functions described herein. Control PCBA 14 includes memory 26 that is configured to store data, programmatic software code and/or other information described herein. In one or more embodiments, memory 26 is configured to store control code 28. For example, control code 28 includes instructions that, when executed by processor 24, causes processor 24 to perform the functions described herein such as the functions described with respect to FIG. 2.

Motor drive PCBA 16 includes communication interface 30 for communicating with control PCBA 14 and motor 18. In one or more embodiments, communication interface 30 includes or is replaced by transmitter circuitry and receiver circuitry. Motor drive PCBA includes motor drive processing circuitry 32. Motor drive processing circuitry 32 includes processor 34 and memory 36. In addition to a traditional processor and memory, motor drive processing circuitry 32 may include integrated circuitry for processing and/or control, e.g., one or more processors and/or processor cores and/or FPGAs (Field Programmable Gate Array) and/or ASICs (Application Specific Integrated Circuitry). Processor 34 may be configured to access (e.g., write to and/or reading from) memory 36, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory). Such memory 36 may be configured to store code executable by processor 34 and/or other data, e.g., data pertaining to communication, e.g., configuration motor control system 12, etc.

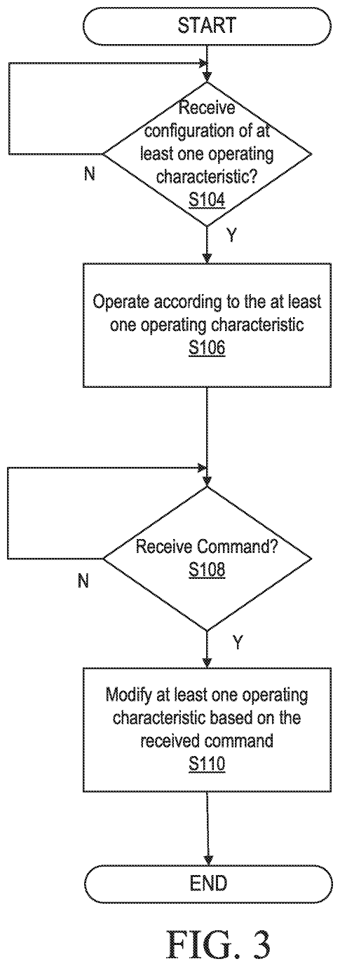

Motor drive processing circuitry 32 may be configured to control any of the methods and/or processes described herein and/or to cause such methods, signaling and/or processes to be performed, e.g., by motor drive PCBA 16. Processor 34 corresponds to one or more processors 34 for motor drive PCBA 16 functions described herein. Motor drive processing circuitry 32 includes memory 36 that is configured to store data, programmatic software code and/or other information described herein. In one or more embodiments, memory 36 is configured to store motor drive code 38. For example, motor drive code 38 includes instructions that, when executed by processor 34, causes processor 34 to perform the functions described herein such as the functions described with respect to FIG. 3.

FIG. 2 is a flow diagram of an example control process of control code 28 in accordance with the principles of the invention. Control processing circuitry 22 is configured to determine whether a configuration triggering action occurred (Block S100). In one or more embodiments, a configuration triggering action includes start-up of motor control system 12, an error code indication from motor drive PCBA 16, or other action as described herein. In one or more embodiments, Block S100 is omitted or skipped.

Control processing circuitry 22 is configured to configure motor drive PCBA 16 with at least one operating characteristic (Block S102). In one or more embodiments, the at least one operating characteristic includes PID loop parameters, minimum, maximum, and default speeds, ramp rates, motor configuration, current limit, and current limit response, etc. In one or more embodiments, the control processing circuitry 22 configures the at least one operating characteristic of motor drive PCBA 16 by communicating one or more commands to motor drive PCBA 16 via one or more commands. In particular, these commands are used to control how the motor drive PCB 16 operates. Some of these commands may be sent once at the beginning of operation to set the basic operation of motor 18. Some of these commands could be saved locally to the motor drive PCBA 16 for minimal standalone operation. Other commands are used during operation to control motor 18. The one or more commands include one or more of:
Control Type—Speed controlled, torque controlled, other
Control Method—Digital Communication or Voltage controlled
Current Limit Maximum—Set maximum current of motor 18. Can be used for fault condition detection, battery life, etc.
Current Limit Minimum—Set minimum current. Can be used for fault condition detection, battery life, etc.
Current Limit Response—What motor 18 drive PCBA should do when a current limit is reached. Adjust speed to meet limit, an alert, stop motor 18, continue, etc.
Direction—Direction of motor 18 rotation (CW/CCW)
Default Speed—Set default speed if no “Set Speed” command is sent
PID Loop Parameters—Parameters for control of motor 18
Number of Pole Pairs—Number of pole pairs in motor 18. Used to properly control motor 18.
Other Motor Information—Other motor 18 information as required
Locked Rotor—Locked rotor recovery. No attempt to restart, attempt to restart forever, or the number of restart attempts.
Target Speed—Desired speed of motor 18
Start Motor—Start motor 18 spinning
Stop Motor—Stop motor 18 spinning
Minimum Speed—Minimum speed of motor 18. Can be used to set a minimum speed for boundary condition (IE: minimum airflow, etc.) or fault conditions
Maximum Speed—Maximum speed of motor 18. Can be used to set a maximum speed for boundary condition (IE: maximum airflow, etc.) or fault conditions
Minimum Torque—Minimum torque of motor 18. Can be used to set a minimum torque for boundary condition (IE: minimum airflow, etc.) or fault conditions
Maximum Torque—Maximum torque of motor 18. Can be used to set a maximum torque for boundary condition (IE: maximum airflow, etc.) or fault conditions
Ramp Up Rate—Change the rate of speed increase
Ramp Down Rate—Change the rate of speed decrease
Get Speed—Get the speed motor 18 is actually running
Get Errors—Get the error codes from the motor drive PCB 16
Over Current
Over Speed
Under Speed
Locked Rotor
Ramp Up Error
Ramp Down Error
Start Error
Stop Error
Maximum Speed Boundary
Minimum Speed Boundary
   Each command and/or corresponding command value may be indicated by a specific value and/or word. Motor control PCB 16 and control PCB 14 work together to control motor 18 according to the specifications.

In one or more embodiments, the communication between control processing circuitry 22 and motor drive processing circuitry 32 is performed using a control protocol. Commands are sent from control processing circuitry 22 to motor drive processing circuitry 32, and responses are received at control processing circuitry 22 from motor drive processing circuitry 32. In one or more embodiments, the control protocol takes place over a Serial Peripheral Interface (SPI) Bus that connects control processing circuitry 22 with motor drive processing circuitry 32; however, the disclosure is not limited to SPI and other synchronous serial communication interfaces and/or communication interfaces may be implemented.

Example commands of the control protocol:

| Command | Command | Read/ | | |
|---|---|---|---|---|
| Group | Description | Write | Command | Parameter |
| Motor | Direction | w | 0x01 | 0-0xFF |
| Parameter | Min Speed | w | 0x02 | 0-0xFF |
| | Max Speed | w | 0x03 | 0-0xFF |
| Running | Start | w | 0x50 | 0-0xFF |
| | Stop | w | 0x51 | 0-0xFF |
| | Target Speed | r/w | 0x52 | 0-0xFF |
| | Get Speed | r | 0x62 | 0-0xFF |
| | Get Error | r | 0x63 | 0-0xFF |
| Temporary | Speed Control Method | w | 0x70 | 0-0xFF |
| Parameters | Direction | w | 0x71 | 0-0xFF |
| Do Not Use | | | 0x00 | |
| | | | 0xFF | |
| Motor | Current Limit | r/w | 0x04 | |
| Parameter | PID Loop parameters | r/w | 0x05 | |
| | Pole Pairs | r/w | 0x06 | |
| Running | Get Status | r | 0x60 | |
| | Get Current | r | 0x61 | |

In one or more embodiments, the control protocol includes one or more of the above commands. Of note, the above commands are provided as an example only. It is contemplated that implementations may have fewer or more commands than those provided above, and may even include different commands than those provided above.

Example message format used in the control protocol:

| Direction | Command | Parameter | Checksum | Notes: |
|---|---|---|---|---|
| Tx | TC | TP | TCKSUM | TCKSUM0 = |
| | | | | bitwise-xor |
| | | | | of TC0 and TP0 |
| | Response | Parameter | Checksum | |
| Rx | RC | RP | RCKSUM | RCKSUM0 = |
| | | | | bitwise-xor |
| | | | | of RC0 and RP0 |
| | | | | if command |
| | | | | received correctly, |
| | | | | RC0 = T0 \| 0x80 |

In one or more embodiments, the message format is as shown in the above table. Of note, the message format is provided as an example only. It is contemplated that implementations may have a different message format than the format shown above.

Message Sequence used in the control protocol:

| Tx | Rx | Notes: |
|---|---|---|
| TC0 | 0xFF | 1st Command |
| TP0 | 0xFF | |
| TCKSUM0 | 0xFF | |
| 0xFF | RC0 | 1st Response |
| 0xFF | RCP0 | |
| 0xFF | RCKSUM0 | |
| TC1 | 0xFF | 2nd Command |
| TP1 | 0xFF | |
| TCKSUM1 | 0xFF | |
| 0xFF | RC1 | 2nd Response |
| 0xFF | RP1 | |
| 0xFF | RCKSUM1 | |

In one or more embodiments, the message sequence is as shown in the above table. Of note, the message sequence is provided as an example only. It is contemplated that implementations may have a different message sequence than the sequence shown above.

FIG. 3 is a flow diagram of an example motor drive process of motor drive code 38 in with the principles of the invention. Motor drive processing circuitry 32 is configured to determine whether a configuration of at least one operating characteristic has been received (Block S104). For example, motor drive processing circuitry 32 determines whether one or more commands have been received from control PCBA 14. If motor drive processing circuitry 32 determines a configuration of at least one operating characteristic has not been received, processing circuitry 32 repeat Block S104. If motor drive processing circuitry 32 determines a configuration of at least one operating characteristic has been received, motor drive processing circuitry 32 operates according to the at least one operating characteristic, as described below (Block S106). Motor drive processing circuitry 32 is configured to determine whether at least one command is received (Block S108). For example, motor drive processing circuitry 32 may receive one or more commands during operation of motor control system 12. If motor drive processing circuitry 32 determines one or more commands have not been received, block S108 is repeated.

However, if motor drive processing circuitry 32 determines one or more commands have been received, motor drive processing circuitry 32 modifies at least one operating characteristic based on the received one or more commands (Block S100). In one or more embodiment, Blocks S108 and S110 are continuously or periodically performed during operation of motor control system 12 or after startup of motor control system 12.

Generally, motor control system 12 will have two PCB assemblies (PCBA) related to blower motor operation, namely control PCBA 14 and motor drive PCBA 16. These two PCBAs 14 and 16, minimum communicate at startup to configure motor drive PCBA 16 according to the specifications about how motor drive PCBA 16 should operate. Once the setup communication is complete motor 18 would start to run according to the setup. Control PCBA 14 would communicate with motor drive PCBA 16 as to what motor drive PCBA 16 needs to do such as speed up or slow down.

Motor control system 12 Startup—When motor control system 12 is first turned on or activated, control PCBA 14 communicates to motor drive PCBA 16 at least one operational characteristic such as but not limited to PID loop parameters, maximum, and default speeds, ramp rates, motor configuration, current limit, and current limit response, etc. Usually these types of items would be set once, at application of power, but could also be dynamically changed while motor control system 12 is active or running.

Motor control system 12 Running—Once motor control system 12 is running, control PCBA 14 sends commands to motor drive PCBA 16 instructing motor drive PCBA 16 what to do. Control PCBA 14 can communicate to motor drive PCBA 16 at least one operational characteristic such as but not limited to speed up/down (target speed), get error codes, start, stop, and get actual running speed. While running, motor drive PCBA 16 would monitor its current, voltage, and speed and then make the proper adjustments to maintain the target speed (or torque depending on required control). During normal operation, the error/tach output will toggle at a frequency proportional to the RPM of motor 18, by default this indicates to control PCBA 14 that motor drive PCBA 16 is running correctly and at what speed.

If motor drive PCBA 16 detects an error such as running outside one or more operational characteristics such as the speed range, over-current, locked rotor, or other errors, motor drive PCBA 16 can set the error/TACH pin to an error condition (either high or low), to immediately communicate to control PCBA 14 that there is an error. Motor drive PCBA 16 then sends the error code to control PCBA 14. In one or more embodiments, motor drive PCBA 16 will continue to try to run at its last known running condition, i.e., operating characteristics, unless it is a locked rotor or current limit condition. If the error is one of these cases, motor drive PCBA 16 will respond according to its programming set up at power on/start-up/activation. Otherwise, control PCBA 14 will receive the error code and determine how to modify at least one operational characteristic according the product specifications (marketing) and communicate the modified at least one operational characteristic to motor drive PCBA 16 what to do.

This interaction between control PCBA 14 and motor drive PCBA 16 eliminates the need for additional firmware programming of the motor drive PCBA. This interaction dynamically changes the operation of motor control system 12. Things like airflow rate changes due to head top type could potentially be optimized for things like better flow control or battery performance. It also means that features can easily be changed and not rely on a predetermined motor control algorithm.

Interface Connections of motor control system 12: Motor Power, Motor Ground, Logic Power, Logic Ground, Digital Communication Signals (wired and/or wireless), Error/TACH, Mode Pin and Voltage Control/PWM Control.

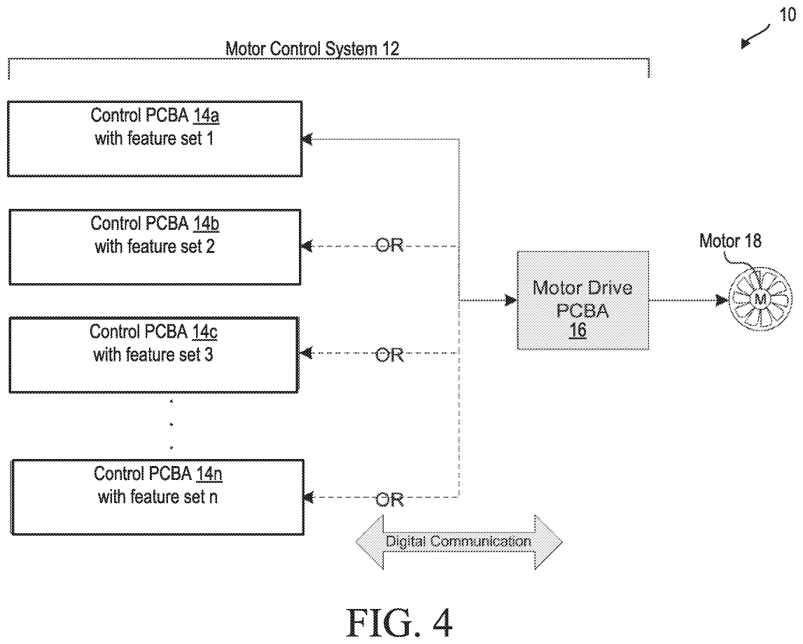

FIG. 4 illustrates a block diagram of an example motor control system 12 in accordance with the principles of the invention. In particular, each of control PCBAs 14a-14n include respective operating characteristics such that control PCBAs 14a-14n include one or more different operational characteristics and/or define different values for one or more of the same operational characteristics. For example, Control PCBA 14a includes operational characteristics defined by feature set 1, control PCBA 14b includes operational characteristics defined by feature set 2, control PCBA 14c includes operational characteristics defined by feature set 3, and control PCBA 14n includes operation characteristics defined by feature set n. For example, feature set 1 includes a first proportional-integral-derivative (PID) loop parameter, first minimum speed and first maximum speed, while features set 2 includes a second proportional-integral-derivative (PID) loop parameter, second minimum speed and second maximum speed, different from feature set 1. In another example, feature set 1 includes a first proportional-integral-derivative (PID) loop parameter, first minimum speed and first maximum speed, while features set 2 includes a first ramp rate, first motor configuration, first current limit and first current limit response. As used herein, control PCBA 14 refers to one or more of PCBAs 14a-14n.

However, using the commands described herein, the disclosure is advantageously configured to use the same motor drive PCBA 14 configuration to support any of PCBS 14a-14n. Therefore, motor drive PCBA 14 can dynamically change the way it operates based on commands from control PCBA 14.

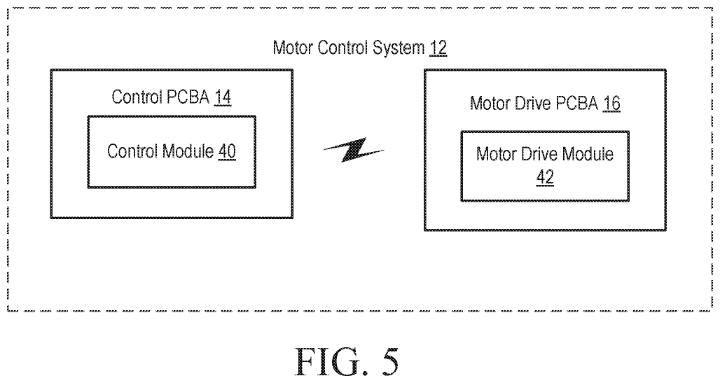

FIG. 5 is a block diagram of an alternative embodiment of motor control system 12 in accordance with the principles of the invention. Control PCBA 14 includes control module 40 that is configured to perform the control process as described above with respect to control code 28. Motor drive PCBA 16 includes motor drive module 42 that is configured to perform the motor drive process as described above with respect to motor drive code 38.

While the disclosure has been described with reference to motor control system 12, the teachings of the inventions are equally applicable to other control and/or drive systems. Also, while the disclosure has been described with respect to printed circuitry board assemblies, the disclosure is equally application to other circuit assemblies. Further, in one or more embodiments motor control system 12 includes one or more of elements 14, 16 and 18, where the remaining elements are in communication with motor control system 12. It will be appreciated by persons skilled in the art that the present embodiments are not limited to what has been particularly shown and described herein above. In addition, unless mention was made above to the contrary, it should be noted that all of the accompanying drawings are not to scale. A variety of modifications and variations are possible in light of the above teachings without departing from the scope of the following embodiments.

1. A motor control system for driving a motor for a powered air purifying respirator (PAPR), the motor control system comprising:
a control printed circuit board assembly (PCBA) including a control processing circuitry;
a motor drive PCBA in communication with the control PCBA and the motor, the motor drive PCBA including a motor drive processing circuitry;
the control processing circuitry configured to configure the motor drive processing circuitry with at least one operating characteristic; and
the motor drive processing circuitry configured to drive the motor according to the at least one operating characteristic.

2. The motor control system of claim 1, wherein the control processing circuitry configures the motor drive processing circuitry with at least one operating characteristic in response to startup of both the control PCBA and motor drive PCBA.

3. The motor control system of claim 1, wherein the at least one operating characteristic includes at least one of proportional-integral-derivative (PID) loop parameters, minimum speed, maximum speed, default speed, ramp rates, motor configuration, current limit and current limit response.

4. The motor control system of claim 1, wherein while the motor drive processing circuitry is driving the motor according to the at least one operating characteristic, the control processing circuitry is configured to communicate at least one command to the motor drive processing circuitry, the at least one command modifying the at least one operating characteristic.

5. The motor control system of claim 4, wherein the at least one command includes a direction of motor rotation, proportional-integral-derivative (PID) loop parameter, number of pole pairs and ramp up rate.

6. The motor control system of claim 1, wherein the motor drive processing circuitry is configured to:
detect that the motor is operating outside of the at least one operating characteristic;
indicate the detection to the control processing circuitry;
the control processing circuitry configured to communicate at least one command to the motor drive processing circuitry in response to the indication of the detection, the at least one command modifying the at least one operating characteristic.

7. The motor control system of claim 1, wherein the at least one operating characteristic includes at least one of a motor power, motor ground, logic power, logic ground, mode pin and pulse-width modulation (PWM) control.

8. A method for a motor control system for driving a motor for a powered air purifying respirator (PAPR), the motor control system including a control PCBA and a motor drive PCBA, the control PCBA including control processing circuitry, the motor drive PCBA including motor drive processing circuitry and being in communication with the motor, the method comprising:
configuring the motor drive processing circuitry with at least one operating characteristic; and
driving the motor according to the at least one operating characteristic.

9. The method of claim 1, wherein the configuration of the motor drive processing circuitry with at least one operating characteristic is in response to startup of both the control PCBA and motor drive PCBA.

10. The method of claim 1, wherein the at least one operating characteristic includes at least one of proportional-integral-derivative (PID) loop parameters, minimum speed, maximum speed, default speed, ramp rates, motor configuration, current limit and current limit response.

11. The method of claim 1, wherein while the motor drive processing circuitry is driving the motor according to the at least one operating characteristic, the method further includes communicating at least one command to the motor drive processing circuitry, the at least one command modifying the at least one operating characteristic.

12. The method of claim 4, wherein the at least one command includes a direction of motor rotation, proportional-integral-derivative (PID) loop parameter, number of pole pairs and ramp up rate.

13. The method of claim 1, further comprising:
detecting that the motor is operating outside of the at least one operating characteristic;
indicating the detection to the control processing circuitry;
communicating at least one command to the motor drive processing circuitry in response to the indication of the detection, the at least one command modifying the at least one operating characteristic.

14. The method of claim 1, wherein the at least one operating characteristic includes at least one of a motor power, motor ground, logic power, logic ground, mode pin and pulse-width modulation (PWM) control.
